(19) United States
(12) Patent Application Publication
(10) Pub. No.: US 2014/0324474 A1
(43) Pub. Date: Oct. 30, 2014

(54) METHOD AND SYSTEM FOR DATA COLLECTION AND MANAGEMENT FOR USE IN HEALTH DELIVERY SETTINGS WITH MULTIPLE CAPITATED PAYMENT RULE SETS

(71) Applicant: Linda Kunz, Milwaukee, WI (US)

(72) Inventor: Linda Kunz, Milwaukee, WI (US)

(21) Appl. No.: 14/327,330

(22) Filed: Jul. 9, 2014

Related U.S. Application Data
(63) Continuation-in-part of application No. 12/302,241, filed on Apr. 3, 2009, now abandoned.

(51) Int. Cl. G06F 19/00

(52) U.S. Cl. CPC G06F 19/328; G06F 19/322
USPC 705/3

(57) ABSTRACT

A data collection and data management system and method enables an entity user, such as a corporation, that owns and operates more than one type of health delivery setting to coordinate and control to optimize care, and coordinate reimbursement outcomes for multiple health delivery settings with multiple capitated payors and rule sets operating. Base raw data is input by the multiple health delivery settings, translated and cleaned for use in a standardized format, and then processed for multiple uses in accordance with a pre-programmed scheme.

This application is a continuation-in-part of application Ser. No. 12/302,241 filed Apr. 3, 2009, which claims the benefit of PCT/US2006/20181 filed May 24, 2006.

### FIELD OF THE INVENTION

The present invention relates generally to the fields of data collection and data management. It also relates generally to systems and methods that are used in the fields of data collection and data management. More particularly, it relates to a system and method of data collection and data management that coordinates health and business operation data collection across more than one health delivery setting with multiple capitated payment rule sets operating. It also relates to a system and method that enables an entity user, such as a corporation, that owns and operates more than one type of health delivery setting to coordinate and calculate reimbursement outcomes for multiple health delivery settings each having multiple payors.

### BACKGROUND OF THE INVENTION

The United States government has mandated the availability of portable and private Electronic Health Records (EHR) on a network for access by a patient, and the patient's caregivers, each being dispersed in multiple locations. The caregivers are located in various Health Delivery Settings and should have access to a required data set, all to be mandated by the United States government.

Individual Health Delivery Settings such as assisted living facilities, and nursing homes operate independently of others, each Health Delivery Setting having medical care, documentation and “best practice” procedures that are specific to it. These practices are often described using very different medical terms embedded in very different, but required, patient-assessment documents and forms. Often, the best practices are specific to each Health Delivery Setting and each Health Delivery Setting is required to flow through to specific required assessment documents and submissions for accurate reimbursement. For example, detailed descriptions needed for patient Activities of Daily Living (ADL) is documented for both care and reimbursement purposes very differently in each of the Health Delivery Setting situations mentioned above.

What is needed is a system and method for corporate entities having multiple Health Delivery Settings with multiple payor situations to create “interoperable” and “shared” electronic data in their corporate neighborhood of one or more Health Delivery Setting. The corporate groupings that have one or more different types of Health Delivery Setting operate with aligned budgets and financing. The reimbursement of each Health Delivery Setting is very different. Accordingly, what is also needed is a way that each Health Delivery Setting can be linked by a common data base of clinical and reimbursement focused information. Each Health Delivery Setting not only has a very different mechanism for reimbursement for care, but some have multiple payer sources including federal Medicare Part A, federal Medicare Part B and Medicaid which is regulated by the state in which operation of the Health Delivery Setting takes place, with required documentation and assessment tools chosen by the particular state of Health Delivery Setting operation. Some state examples include “TILES” in Texas, “PRI” in New York, and “MMQ” in Maine. Various other states use standard reimbursement tools but exercise their right to customize how the data is used to rate payments by “add on” questions in what is typically called section “S” for state authority.

Another problem that can arise is that regional private pay insurance companies often rely on specific Minimum Data Set (MDS) outcomes for payment. MDS collection is accomplished by means of a form that is used, for example, for nursing home resident assessment and care screening. The form is configured to ask for information that is mandated by Medicare for proper patient reporting and provider reimbursement. The MDS form includes a plurality of patient-sensitive considerations including, for example, observation and rating of patient difficulties or assistance needed to perform life-sustaining ADLs, patient communication/hearing patterns, mood and behavior patterns, physical functioning and structural problems, special treatments, and so on. Also, some states, such as Minnesota, regulate equalization of service payment rates for all non Medicare payer sources which can include private pay, insurance and Medicaid.

An additional complication is that until 2012 the main payor for Medicare eligible patients was the federal government, which had one rule set for making payments. Under federal healthcare reform, healthcare providers are faced with the same patient census but now may have up to thirty (30) different insurance payors and HMO contracts with highly variable contract terms in effect. Multiple HMO contracts with diverse contract terms have complicated the clinical and business criteria for Health Delivery Settings trying to receive payment for their services.

For example, payment criteria changes vary. For example, some managed care/HMO payment criteria still apply federal Prospective Payment rules using a standard assessment such as Minimum Data Set (“MDS”) or Outcome and Assessment Information Set (“OASIS”) but with modified requirements for workflow and eventual submission and different payment rates. However, some managed care/HMO payment criteria now require daily payment determinations involving three (3) to five (5) Levels of Care that are unique to each HMO contract.

Additionally, there may be several managed care/HMO contracts, each of which has its own specified set of clinical care terms that qualify the patient for daily Levels of Care and payment, which makes daily tracking and substantiating reimbursement claims very complex. In addition, there are at least two other terms that vary in managed care/HMO insurance contracts. First, often the provider can bill directly for costly medication exclusions. However, billing for exclusions can either add to or override the main Level of Care payment qualifications. Second, each managed care/HMO insurance company has its own set of contract requirements for notices and the workflow, in order for the care provider to get be preapproved and then ultimately paid for care.

In view of the foregoing, it can be appreciated that a single episode of care for an elderly patient can be reimbursed by payor sources operating under different payment rule sets with one or two of them paying for separate, but overlapping, treatments or sequential time periods of the same episode of care. All payers use different mechanisms for payment for reimbursement for care of the elderly that may require different “best practice” medical assessment data and reporting templates for each payer source.

For example, it is known that Skilled Nursing Facilities gain reimbursement from the submission of the MDS form or the MDS information. The same is true of sub-acute nursing facilities. Rehab hospitals, on the other hand, gain reimbursement from the submission of a special Inpatient Rehab Assessment tool (IRFPAI). An Assisted Living/Assisted Living Facilities can gain reimbursement from the submission of the home care assessment form called OASIS (Outcome and Assessment Information Set) when the patient needs skilled care. Hospitals gain lump sum reimbursement from the submission of a UB92 that assigns accurate diagnosis (procedural/diagnosis or Diagnosis Related Groupings (DRG) codes) and accurate CPT-4 codes set fee payments. In outpatient clinics, doctors' notes are used to support CPT-4 procedures and to set fee payments in accordance with managed care/HMO contracts. As such, it can be readily understood that a corporate entity that focuses on elder care and owns or manages two or more types of facilities within different Health Delivery Setting faces complex data coordination and reporting needs. What is needed is a system and method of data collection and data sharing that coordinates health and business operations across more than one Health Delivery Setting. To date, no system of data collection coordinates health and business operation data collection across more than one Health Delivery Setting having multiple payors with diverse sets of rules for reimbursement

### SUMMARY OF THE INVENTION

The system and method of the present invention provides for data collection and data management that also coordinates business operation data collection across more than one Health Delivery Setting. It also provides a system and method that enables an entity user, such as a corporation, that owns and operates more than one type of Health Delivery Setting to coordinate reimbursement outcomes for multiple health delivery settings each having a number of payors that each could have different sets of rules for reimbursement.

The core of the system and method of the present invention is that individual Health Delivery Settings and department users input the medical information that they gather into the system, all consistent with their best practices and language. The system is capable of using translators that are specific to each Health Delivery Setting and department user to translate and then convert the information to data for input into a common database. In this manner, each form of input data is translated into common elements of care and clinical documentation, all with continued links to originating Health Delivery Setting details. This creates, in effect, a single-source, clean and accurate data base. At any time in the future, a Health Delivery Setting-specific algorithm can call up data, analyze it and calculate the parameters needed for decision making at any of the Health Delivery Settings and or a specified managed care/HMO payor, or the corporate entity level. Ultimately, the entity-wide Corporate Entity Information Organization for Sharing (CEIOS) system can conduct constancy checks to compile in decision-making or reimbursement formats specific to the Health Delivery Setting that the patient is being treated in currently or pro-forma reimbursement performance criteria can be reported to predict relative cost and reimbursement outcomes. With this system and method, a corporate entity could make decisions having the benefit of shared Health Delivery Setting data that is interoperable between Health Delivery Settings and payors.

Under the CEIOS system, data can be presented in the best practice language of the Health Delivery Setting needing reports and using data merges originally collected in one or more corporate-owned Health Delivery Setting. Each Health Delivery Setting will have the benefit of using its specific best practice action documented in its specific language but can operate from a single data source. It can be used to produce pro-forma reimbursement and shared clinical observations. The method and system can produce the required corporate reporting format for budget control and utilization for multiple Health Delivery Settings that exist under the same corporate ownership.

An additional purpose of this invention is to provide instantaneous and up to the moment patient case capitated payment qualification under managed care/HMO contracts and to compare these payments to the actual cost of care for each patient case. The system is for use by businesses and clinical case managers across all Health Delivery Settings. Essentially, the system computes each patient's up to date level of care qualification for a contracted capitated payment amount that is calculated using the criteria specified by any of the managed care/HMO contracts,

Federal Bundled Payment programs, ACO contracts and the original federal and state prospective payment systems. The invention deploys processes to analyze and standardize each HMO contact term as one of over 1,000 standard contract term items. Using this information, the system is able to generate notices and reports of important contract terms including: (1) workflow instructions for payment approval; (2) alerts when there is any change in a patient's status that affects payment approval, re-approval and or changed qualifications for capitated daily payment at a level of care; (3) prescribed medication exceptions; and (4) any significant changes in the overall cost of care relative to the payment for each day of care. Processes specific to a patient/payor contract pair are individually applied and when additional contracts apply for primary and secondary or alternate payors the patient records can be processed for more than one contact.

### BRIEF DESCRIPTION OF THE DRAWINGS

FIG. 1 is a schematic diagram illustrating the data and process flow through the CEIOS system.

FIG. 2 is a screenshot of a patient data screen using the claimed invention.

FIG. 3 is a screenshot of the payor selection screen, which is used to match the patient to the patient's insurance or payor according to the claimed invention.

FIG. 4 is a screenshot of the charting function available to healthcare providers according to the claimed invention.

FIG. 5 is a screenshot of one of the reporting functions of the claimed invention.

FIG. 6 is a screenshot showing the daily score of a hypothetical patient using the claimed invention.

FIG. 7 is a portion of a screenshot that demonstrates the ability of the claimed invention to analyze reimbursement outcomes for identical conditions across multiple manage care/HMO contracts.

FIG. 8 is screenshot that demonstrates that shows the ability of the claimed invention to evaluate identify exclusions and exceptions to a managed care/HMO contracts to capture profitability on a per patient basis.

### DETAILED DESCRIPTION

As discussed above, the system and method of data collection and data management of the present invention serves to coordinate health and business operation data collection across more than one health delivery setting. It also enables an entity user, such as a corporation, that owns and operates more than one Health Delivery Setting to coordinate reimbursement outcomes for multiple Health Delivery Settings each having multiple payors. This system and method will be identified herein as a Corporate Entity Information Organization for Sharing, or CEIOS. Financial planning and reporting across multiple Health Delivery Settings is also integrated into the system. Financial reimbursement presentations and submissions require specialized language and know-how that is specific to each Health Delivery Setting, often so specialized that Health Delivery Setting specific reimbursement staff, often called “Utilization and Reimbursement Specialists,” are needed for each Health Delivery Setting. A CEIOS used by the corporate entity enables the coordination and translation of reimbursement sensitive information for use across multiple Health Delivery Settings, all compiled in the format and preferred language for Health Delivery Setting-specific reimbursement or for the corporation's needs.

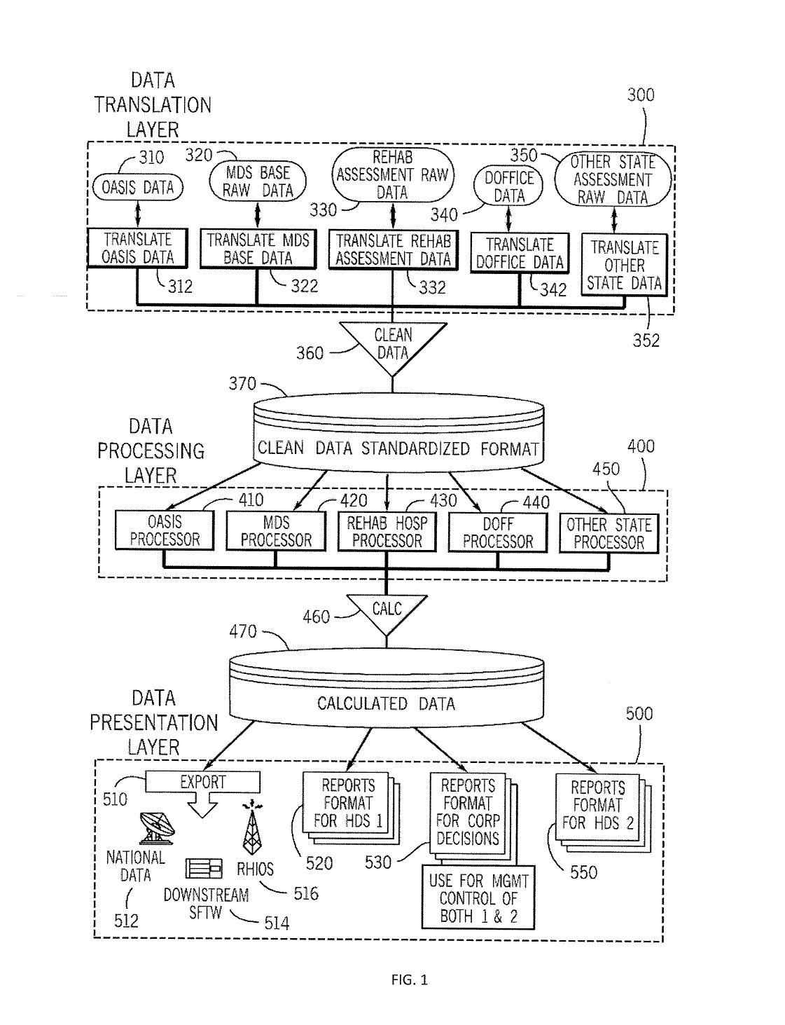

Referring now to the drawings in detail, wherein like numbered elements refer to like elements throughout, FIG. 1 illustrate the CEIOS concept or environment, generally identified 10, that is configured in accordance with the present invention. Although a specific configuration of the CEIOS concept is presented herein, it is to be understood that the invention is not limited to the specific configuration disclosed and that any number of configurations could be presented, all of which are contemplated by the method and system of the present invention.

Referring FIG. 1, it shows a diagram that illustrates in detail a hardware and software architecture according to one embodiment of the invention. And the data flow through the technology system of the CEIOS It is broken down into three primary sections: the “Data Translation Layer 300,” the “Data Processing Layer 400,” and the “Data Presentation Layer 500.” The overall hardware and software architecture supports modular changes to the system at each layer. This means that translation, processing, or presentation modules may be easily added or removed without affecting the underlying application framework.

The Data Translation Layer's 300 sole purpose is to electronically receive input data and convert it into a standard format. This standard format is generic enough to be used for any type of input data, but descriptive enough to be useful as raw data for the Data Processing Layer 400. Any time a new input is added to the system a translator would be added to convert the data. This layer 300 handles all electronic inputs to the system. As shown in FIG. 1, the Data Translation Layer 300 comprises received and inputted OASIS data 310; MDS base raw data 320, rehab assessment raw data 330, doctor office data 340, and other state assessment raw data 350 from relevant Health Delivery Settings. This somewhat unstructured raw data 310, 320, 330, 340, 350 is translated 312, 322, 332, 342, 352 by one or more modules that are pre-programmed for translation and then inputted as “clean” data 360. This clean data 360 is then held in a server 370, which may or not be centralized, for processing. It is to be understood that virtually any format that can be used by a Health Delivery Setting to collect and report data is considered to be within the scope of the method and system of the present invention. The claims herein are not limited to the specific arrangement illustrated in FIG. 1 for the Data Translation Layer 300. The Data Translation Layer 300 is configured to translate any information collection format, using essentially unstructured data and making it structured standardized data.

The Data Processing Layer 400 is responsible for applying business rules to the standardized data. It is where all of the business “knowledge” resides. Each module in this layer 400 contains all of the processes necessary for a complete business need. As shown in FIG. 1, the Data Processing Layer 400 includes, for the example given, an OASIS processor 410, an MDS processor 420, a rehab hospital processor 430, a doctors' office processor 440, and other state assessment processor 450. It is to be understood that the Data Processing Layer 400 that is provided in accordance with the present invention is not limited to the processors listed here. Any and all other types of processors are within the scope of the present invention. Processor modules can be added or removed as desired or required by the system. The processors 410, 420, 430, 440, 450 perform calculations 460 in accordance with a pre-programmed scheme, performing one or more algorithms on the clean data 360 that has been received in a standardized format and the post-processed, or calculated, data 460 can be stored in the database or server 470, which may or may not be centralized, for use by the Data Presentation Layer 500. This layer 500 only uses the standardized post-translated data.

This last layer, the Data Presentation Layer 500, uses the results of the Data Translation and Processing Layers 300, 400 to provide usable data to system employees and customers. The presentation layer 500 can be a web page, a report, a web service, an export, or any other resource or method that the data can be used. This layer 500 contains all of the outputs of the CEIOS system. As shown in FIG. 1, the calculated data 470 can be exported 510 for transmission on a national reporting basis 512, to other RHIOs 516, or to other downstream software 514. The calculated data 470 can also be used in reports for feedback to the individual Health Delivery Setting 520, 550 that has provided raw data and in reports for corporate decisions 530 or at the CEIOS level. Here again, the specific Data Presentation Layer 500 illustrated in FIG. 1 is not a limitation of the method and system of the present invention. It is presented only for the purpose of describing a preferred embodiment of the invention, but is not limiting the claims in any way.

A large facility may have patients who are covered by several different managed care/HMO contracts. The capitated payment system of the claimed invention provides a way in which to match patients to their respective HMO contracts and to automatically generate reimbursement to the Health Delivery Setting based on the managed care/HMO contract upon entry of daily required reports.

However, the first step in process is the digitization of the managed care/HMO contract. Specifically, the claimed invention provides a template for entry of key managed care/HMO contract details. For example, most HMO contracts have a multiple tier rating system that governs the way the facility is reimbursed for the services it provides. Generally speaking, HMO contracts provide for varying levels of reimbursement based on the amount of care provided. The claimed invention provides a template for digitizing the capitation terms of HMO contracts. Digitizing the capitation terms allows a facility to create a custom set of rules for reimbursement under each HMO contract. It further allows for exclusions as necessary under each HMO contract. Once an HMO contract is digitized, the HMO contract can be used for multiple patients, as necessary. For example, a given contract may pay:
$300/day for Level 1 Care
$350/day for Level 2 Care

$400/day for Level 3 Care

$450/day for Level 4 Care

Qualifications for different levels of care may include: assessment of vitals, administration of IVs, tube feedings, rehabilitation services, specialty care, wound assessment and management, use of equipment and supplies, breathing assistance, laboratory and radiology services, among other things. The more care that is necessary and provided the more reimbursement the facility is entitled to. There are also frequently special exceptions for certain treatments and/or prices for drugs. For example, high cost drugs, specialized medical equipment and expensive wound care are often exceptions.

The claimed invention is operable to compile the criteria selected by the healthcare provider and to identify the level of care provided to the patient, categorize the level of care under the HMO contract and thus the entitlement of the facility to reimbursement for the care. Additionally the claimed invention is operable to produce reports that identify the basis for the reimbursement classification.

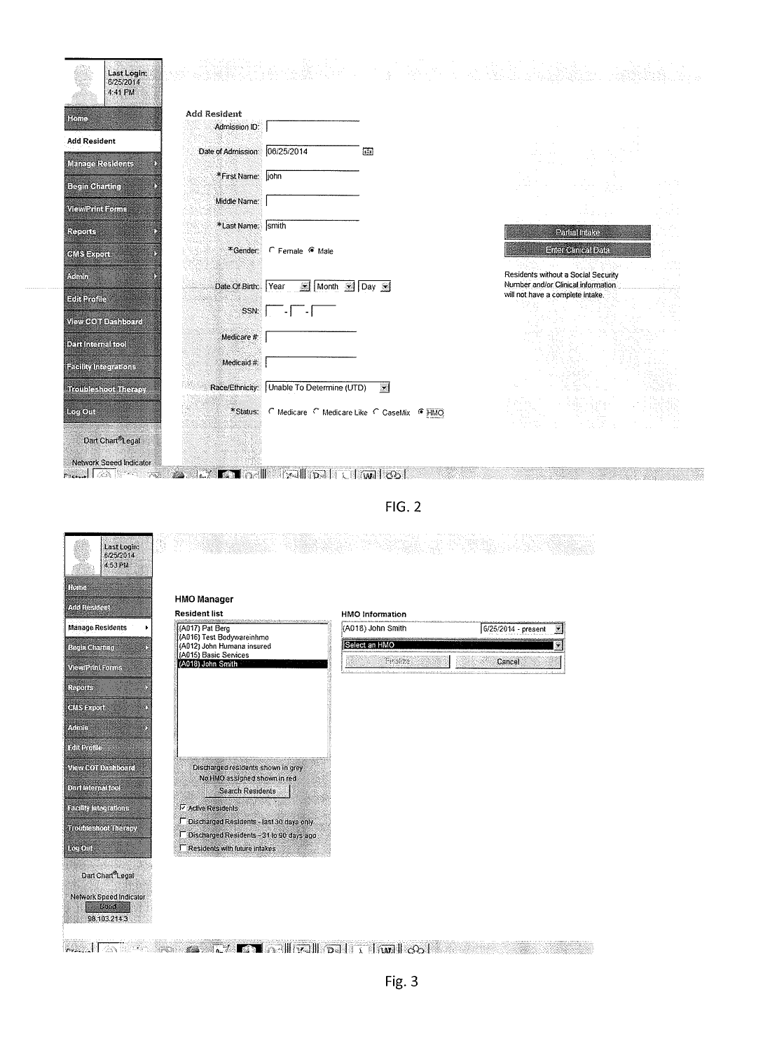

As shown in FIG. 2, individual patients are entered with standard identification criteria including, but not limited to name, gender, date of birth, Social Security number, Medicare Identification number and date of admission. Further identification fields can be added as needed. The initial screen also permits a user to classify the payor status for the patient. Also, as shown in FIG. 2, possible payors include Medicare, Medicare like coverage, and HMO contracts. Additional payors can be added. The payor identification may further include a Case mix calculation. Case mix calculations are adjustments to reimbursement based on the patient population. FIG. 3 essentially shows the way in which patients are matched to their respective insurance payors.

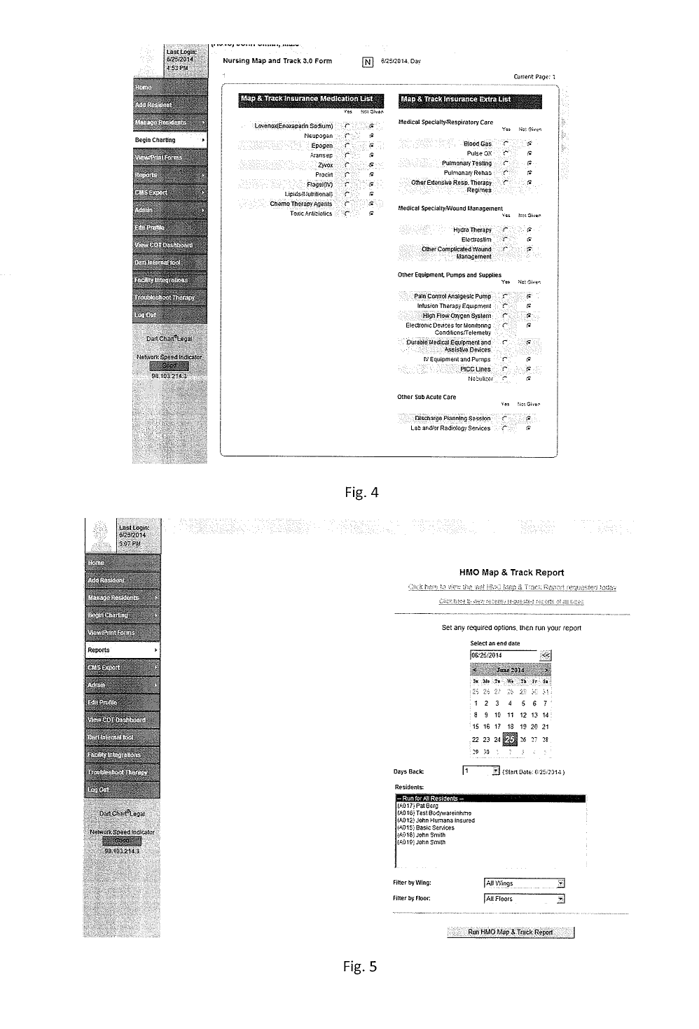

The claimed invention also provides a data recording tool for caregivers. As shown in FIG. 4, the standard data reporting tool, for example, includes a checklist of the items contributing to Levels of Care. While these are standard items, the data recording tool is also highly customizable to include additional criteria that factor into capitation levels under the HMO Contract as well as any excluded items and medications. In practice, the claimed invention provides a checklist for caregivers to use to examine patients and to record their findings. That is, the claimed invention is operable to permit a caregiver to select the criteria applicable to the patient. Thus, after examining a patient, the caregiver is able to use the claimed invention to record his/her findings in the form of a report that is individualized to the patient.

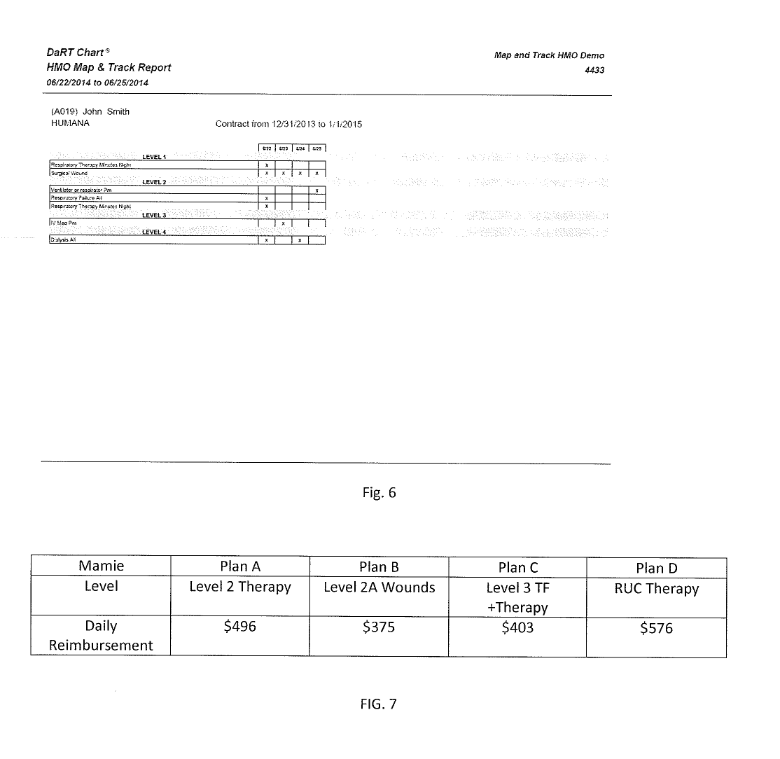

Once the caregiver completes the checklist, the claimed invention is further operable to compile and to categorize the criteria selected by the caregiver to meet reporting and reimbursement requirements. Specifically, the claimed invention takes the criteria input by the caregiver and, using the template generated using the HMO contract, the claimed method is operable to categorize each of the criteria identified by the caregiver to generate a daily report that lists the type of care provided to a given patient as well as how the care is classified under the HMO contract for reimbursement. Referring now to FIG. 5, a number of reports are available to a Health Delivery Setting. One such report would rate the criteria input by the caregiver using the terms of the HMO contract as shown in FIG. 6.

Additionally, the claimed invention is operable to provide on demand analytics for Health Delivery Settings including reports tailored by the claimed system in accordance with the contracts variable term items that show an immediate comparison of total facility standard costs of patient care versus total capitated payments. This type of analysis can be scaled up for overall case analysis at the facility and corporate level.

FIG. 7 demonstrates a form of contract analysis. FIG. 7 shows the reimbursement levels availability to a Health Deliver Setting using a hypothetical patient “Mamie” under a variety of managed care/HMO contracts. Thus, the claimed invention permits a user to compare the reimbursement available from a plurality of managed care/HMO contracts. Such an analysis is critical to the ability of a Health Delivery Setting's ability to negotiate profitable managed care/HMO contracts.

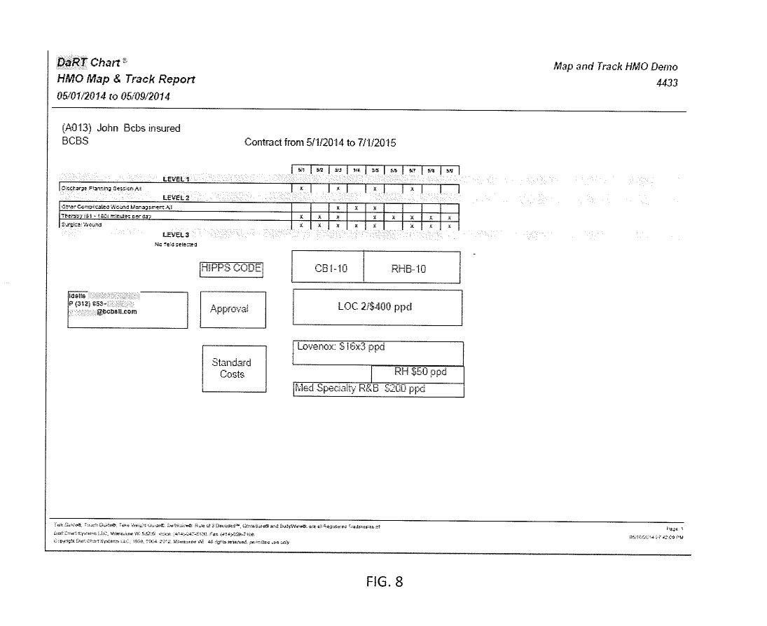

FIG. 8 demonstrates an additional reporting feature of the claimed invention, that is the ability of the claimed invention to track exclusions and exemptions to a given reimbursement rate. For example, the facility is entitled to $400/day for caring for an individual in the hypothetical Mr. Bcbs's condition. However, Mr. Bcbs has a number of treatments that reduce the profitability associated with his care substantially. For example, Mr. Bbcbs is taking Lovenox, which costs $48/day, requires a private room at $200/day and requires some therapy at $50/day. As shown in FIG. 8, the claimed invention is operable to track these and other exemptions and exceptions to insurance contracts on a patient by patient basis.

The CEIOS system of the present invention provides a system whereby raw data can be presented in the best practice language of the Health Delivery Setting needing reports and using merges of data originally collected in one or more corporate-owned Health Delivery Setting for purposes of maximized patient treatment, maximized resource utilization and uniform data reporting for payment reimbursement and other corporate purposes. Under the method and system of the present invention, each Health Delivery Setting has the benefit of using its specific best practice action, all of which is documented in its specific language, but which can also operate from a multiple or single data source created by multiple corporate-owned Health Delivery Setting.

Based upon the foregoing, it will be apparent that there has been provided a new, useful and non-obvious system and method that provides for data collection and data management while coordinating health and business operation data collection across more than one Health Delivery Setting. It also provides a system and method that enables an entity user, such as a corporation, that owns and operates more than one type of Health Delivery Setting to coordinate reimbursement outcomes for multiple Health Delivery Settings each having multiple payors.

What is claimed is:

1. A server based information system that is used to track patient care, manage patient care and obtain reimbursement for patient care in a capitated payment system comprising the steps of:
identifying a patient eligible for the capitated payment system;
recording an eligible patient's personally identifiable information in the server based information system;
identifying any capitated payment coverage for health care services applicable to a patient;
providing a database with a customizable set of rules and exceptions and allowing customization of the rules and exceptions for capitated payment coverage on the server based information system;
customizing the rules and exceptions on the server based information system according to the capitated payment plan and storing the customized rules and exceptions for the capitated payment plan on a server;
matching the capitated payment plan to the individual covered by the capitated payment plan and recording the link between the individual and the capitated payment plan on the server;
providing a data entry device for a caregiver, the data entry device being operable to communicate with the server and to present a caregiver with a list of services that are offered to a patient from a Health Delivery Setting that includes capitation payment criteria, the data entry device being further operable to permit a caregiver to record the services offered to a patient and to transmit the services recorded to the server;
compiling the information recorded by the caregivers into a database and categorizing the information recorded by the caregivers according to the customized rules and exceptions for the applicable capitation plan on the server; and
computing the capitated payment per patient based on the customized rules and exceptions stored on the server.

2. The server based information system of claim 1 further comprising the step of sharing reimbursement information across multiple Health Delivery Settings.

3. The server based information system of claim 1 further comprising the step of providing a capitation report categorizing the care provided to a patient by capitation level.

4. The server based information system of claim 1 further comprising the step of monitoring the profitability of managed care/HMO contracts on a per patient basis.

5. The server based information system of claim 1 further comprising the step of comparing the relative reimbursement outcomes for a patient between two or more health delivery settings.

6. The server based information system of claim 1 further comprising the step of including exceptions and exceptions to managed care/HMO contracts to compute a daily reimbursement rate an an individual patient basis.

7. A server based information system that is used to track patient care, manage patient care and obtain reimbursement for patient care in a capitated payment system comprising the steps of:
identifying a patient eligible for the capitated payment system;
recording an eligible patient's personally identifiable information in the server based information system;
identifying any capitated payment coverage for health care services applicable to a patient;
providing a database with a customizable set of rules and exceptions and allowing customization of the rules and exceptions for capitated payment coverage on the server based information system;
customizing the rules and exceptions on the server based information system according to the capitated payment plan and storing the customized rules and exceptions for the capitated payment plan on a server;
matching the capitated payment plan to the individual covered by the capitated payment plan and recording the link between the individual and the capitated payment plan on the server;
providing a data entry device for a caregiver, the data entry device being operable to communicate with the server and to present a caregiver with a list of services that are offered to a patient from a Health Deliver Setting that includes capitation payment criteria, the data entry device being further operable to permit a caregiver to record the services offered to a patient and to transmit the services recorded to the server;
compiling the information recorded by the caregivers into a database and categorizing the information recorded by the caregivers according to the customized rules and exceptions for the applicable capitation plan on the server;
computing the capitated payment per patient based on the customized rules and exceptions stored on the server; and
comparing the reimbursement information for a given patient using multiple managed care/HMO contracts.

8. The server based information system of claim 7 further comprising the step of sharing reimbursement information across multiple Health Delivery Settings.

9. The server based information system of claim 7 further comprising the step of providing a capitation report categorizing the care provided to a patient by capitation level.

10. The server based information system of claim 7 further comprising the step of monitoring the profitability on a patient-by-patient basis by including exclusions and exceptions in the capitation computation.

11. The server based information system of claim 7 further comprising the step of comparing the relative reimbursement outcomes for a patient between two or more health delivery settings.
